(19) United States
(12) Patent Application Publication
(10) Pub. No.: US 2001/0028750 A1
(43) Pub. Date: Oct. 11, 2001

(54) Image processing apparatus and image processing method employing the same

(75) Inventor: Masanori Asakura, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 09/816,856

(22) Filed: Mar. 22, 2001

(30) Foreign Application Priority Data
Mar. 31, 2000 (JP) 2000-99975

(51) Int. Cl. G06K 9/42; G06K 9/44; G06K 9/32

(52) U.S. Cl. 382/298; 382/258

(57) ABSTRACT

An image processing method and an image processing machine that can suppress emergence of vertical streaks in a resulting image with a simple system when reducing or enlarging a pseudo gray-scale image. A counter which counts a reference clock necessary to interpolate or thin out inputted pixel data in every line is not reset at every line. Accordingly, each line has its own bit numeral numbers for the pixels requiring interpolation. The interpolated pixel data are positioned randomly in the resulting image, so that the emergence of vertical streaks is prevented.

### CROSS REFERENCES TO RELATED APPLICATION

This application claims priority under 35 USC 119 of Japanese Patent Application No. 2000-99975 filed on Mar. 31, 2000, the entire disclosure of which is incorporated herein by reference.

### BACKGROUND OF THE INVENTION

1. Field of the Invention

The present invention relates to an image processing apparatus and an image processing method employing the same which provide interpolation processing or thin-out processing for the inputted pixel data of prescribed number, i.e., for one scanning line.

2. Description of the Related Art

In order to enlarge or reduce an inputted image, a counter is installed to count a reference clock which controls input-output of pixel data of the image. In accordance with an enumerated value by the counter, interpolation or thin-out processing for the pixel data is performed at every pixel data of prescribed number according to a specified magnification. Such interpolation or thin-out processing conventionally handles the pixel data of one scanning line as one unit and the enumerated value by the counter is re-set at every line.

In FIGS. 8A and 8B of the accompanying drawings, there are shown the pixel data given the image enlargement processing (the interpolation processing of pixel data) in conventional way as described in the above. For each prescribed number of pixels, the output time duration of one pixel datum is prolonged twice as long enough to read out the same pixel datum twice from a memory (not shown). Since an enumerated value in a counter is reset at every line in conventional way, the pixel data that require the interpolation have the same bit number in all lines as shown in FIG. 8A. (In this example, the data are in 3rd bit, 7th bit, 10th bit, 15th bit, . . . ) In FIG. 8A, the interpolated pixels have hatching. Therefore, the pixel data after finishing the enlargement processing become like the ones shown in FIG. 8B and the interpolated pixels are located exactly in the same position in whichever lines they are.

Accordingly, when the pixel data having been treated with interpolation or thin-out processing are printed on paper, there appear vertical streaks called moire in the sub-scanning direction, which causes the image degradation. Such vertical streaks are particularly noticeable in the case of pseudo gray-scale image.

Therefore, it is proposed that random numbers from a random number generator circuit are set at the counter in the beginning of each line and the position of pixels requiring interpolation or thin-out processing at each line are made to differ from each other (Japanese Patent Application, Laid Open Publication No. 4-335769). However, a random number generator circuit is prerequisite for this method, which inevitably makes the whole apparatus complex and large-scale.

### SUMMARY OF THE INVENTION

It is an object of the present invention to provide an image processing apparatus and an image processing method employing the same which suppress the emergence of vertical streaks with a simple system which does not reset an enumerated value of the counter at the beginning of every line.

In accordance with a first aspect of the present invention, there is provided an image processing method for performing interpolation or thin-out processing to pixel data in accordance with an enumerated value in a counter counting a reference clock at every one unit which is composed of prescribed number of pixel data, characterized in that a final enumerated value in said counter for one unit is not reset but kept in the counter and a counting processing starts again at the beginning of the next unit with a consecutive enumerated value from the kept final enumerated value.

The counter keeps the final enumerated value, that is from the former unit (the former line) having the prescribed number of pixel data, instead of resetting it at the beginning of the current unit (the current line) and uses a consecutive enumerated value from said final enumerated value. Consequently, each unit (each line) has each different position of the pixel data that require the interpolation or thin-out processing, which suppresses the emergence of vertical streaks in a resulting image.

In accordance with the second aspect of the present invention, there is provided an image processing method for performing interpolation or thin-out processing to pixel data in accordance with an enumerated value of a counter counting a reference clock in a unit which is composed of a prescribed number of pixel data, characterized in that the final enumerated value of the said counter for the former unit is not reset at the beginning of the current unit if said pixel data are pseudo gray-scale but is reset if they are bi-level.

The image processing method does not reset the enumerated value of the counter at the beginning of each unit (each line) in a halftone image that likely produces vertical streaks, but resets the enumerated value of the counter at the beginning of each unit in a bi-level image that hardly produces vertical streaks. Therefore, this method allows effective processes according to the types of image.

In accordance with the third aspect of the present invention, there is provided an image processing apparatus for performing interpolation or thin-out processing to pixel image for each unit composed of the inputted prescribed number of pixel data, that includes a memory to store said inputted pixel data, a counter to count a reference clock, and a control unit to control the read of pixel data from said memory in accordance with an enumerated value of said counter and to control resetting or non-resetting of said counter at the beginning of each unit.

This image processing apparatus operates on the interpolation or thin-out processing of pixel data by controlling the read of pixel data from the memory according to the enumerated value of the counter that counts the reference clock. The control unit determines resetting or non-resetting of the enumerated value of the counter at the beginning of each unit. The control unit does not reset the enumerated value of the counter at the beginning of the unit in order to put the pixels that need the interpolation or thin-out processing in different positions, so that the emergence of vertical streaks may be suppressed in a resulting image.

### BRIEF DESCRIPTION OF THE SEVERAL VIEWS OF THE DRAWINGS

FIG. 1 is a schematic diagram showing the flow of pixel data and clock signals in an enlargement processing in accordance with the present invention.

FIG. 2 illustrates a timing chart of the enlargement processing shown in FIG. 1.

FIG. 3A illustrates initial parts of pixel data in three scanning lines when the enlargement processing (the interpolation processing of pixel data) is carried out in accordance with the present invention.

FIG. 3B illustrates a diagram of the three lines after the enlargement processing.

FIG. 4 is a schematic diagram showing the flow of pixel data and clock signals in a reduction processing in accordance with the present invention.

FIG. 5 is a timing chart of the reduction processing shown in FIG. 4.

FIG. 6 is similar to FIG. 1 and illustrates the flow of pixel data and clock signals in the enlargement processing together with a reset signal.

FIG. 7 is a flowchart showing the processing of a reset control device used in FIG. 6.

FIG. 8A shows the initial part of pixel data in three lines when the enlargement processing (the interpolation processing of pixel data) is carried out in accordance with the conventional way.

FIG. 8B shows the three lines after the conventional enlargement processing.

### DETAILED DESCRIPTION OF THE INVENTION

Embodiments of the present invention will now be described with reference to the accompanying drawings.

The first embodiment: Enlargement processing

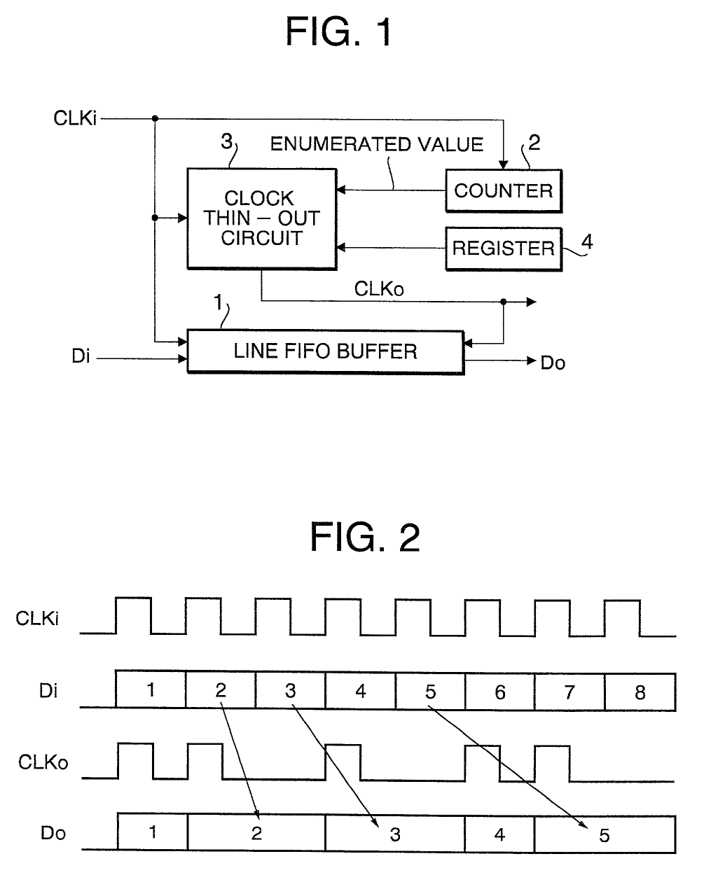

Referring to FIGS. 1 and 2, a line FIFO (First-Input First-Output) buffer 1 inputs pixel data Di one by one in synchronization with the input clock signals CLKi and outputs pixel data Do one by one in synchronization with the output clock signals CLKo. A counter 2 counts the pulses of the input clock signal CLKi, that is to be the reference clock, and outputs the enumerated value to a clock thin-out circuit 3. A register 4, which keeps the timing data showing which pixel data should be interpolated in accordance with the set scaling, outputs the timing data to the clock thin-out circuit 3. The clock thin-out circuit 3 generates the output clock signal CLKo by thinning out the input clock signal CLKi in accordance with the timing data and outputs it to the line FIFO buffer 1.

The pixel data Di are inputted to the line FIFO buffer 1 successively in synchronization with the input clock signal CLKi. The clock thin-out circuit 3 generates the output clock signal CLKo from the input clock signal CLKi by thinning out 3rd clock, 5th clock, 8th clock and other number of clocks in the input clock signal, and outputs it to the line FIFO buffer 1. The timing data that is the base of the thin-out pattern is inputted from the register 4 and the enumerated value of the input clock signal CLKi is inputted from the counter 2. The pixel data Do is output from the line FIFO buffer 1 successively in synchronization with the output clock signal CLKo. Those pixel data Do that should be interpolated are prolonged twice in the time so that said pixel data can be read out again. It allows the enlargement processing with the scaling factor 8/5=160%.

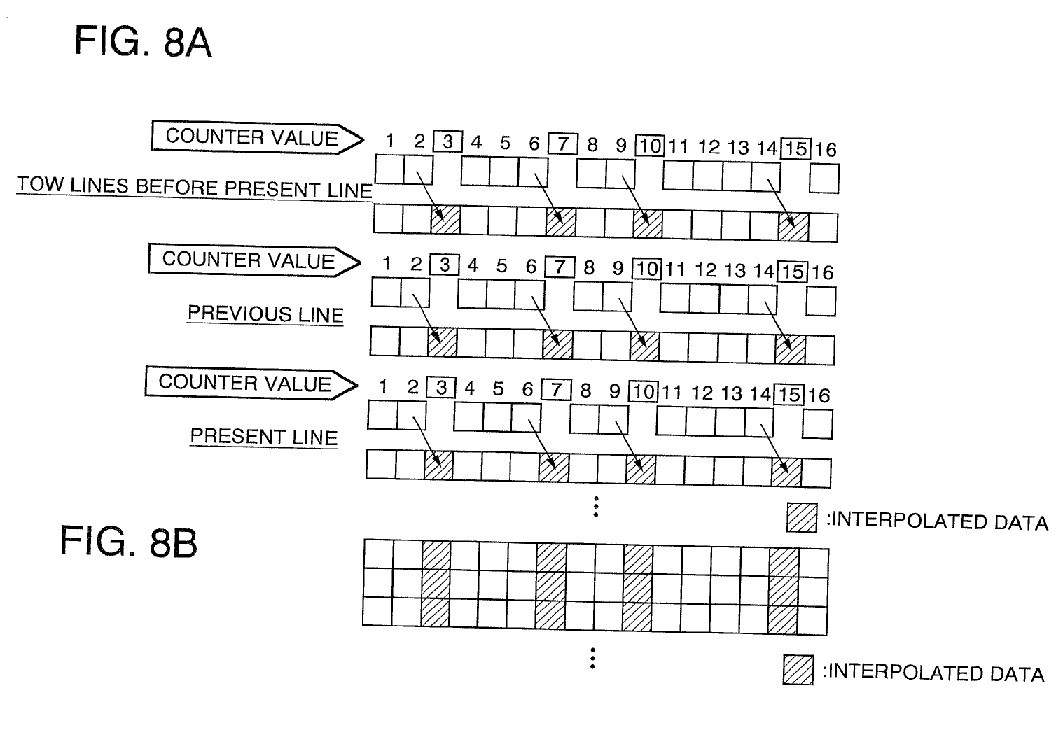

The enumerated value is reset by inputting the reset signal into the counter 2 every time the measurement of one line is over in conventional enlargement processing. Every line has, therefore, all the same interpolation patterns as described before (see FIGS. 8A and 8B), which generates the vertical streaks that are the cause the image degradation.

In the present invention, the reset signal like the above is not inputted into the counter 2 but a consecutive enumerated value from the stored final enumerated value of the prior line is output to the clock thin-out circuit 3.

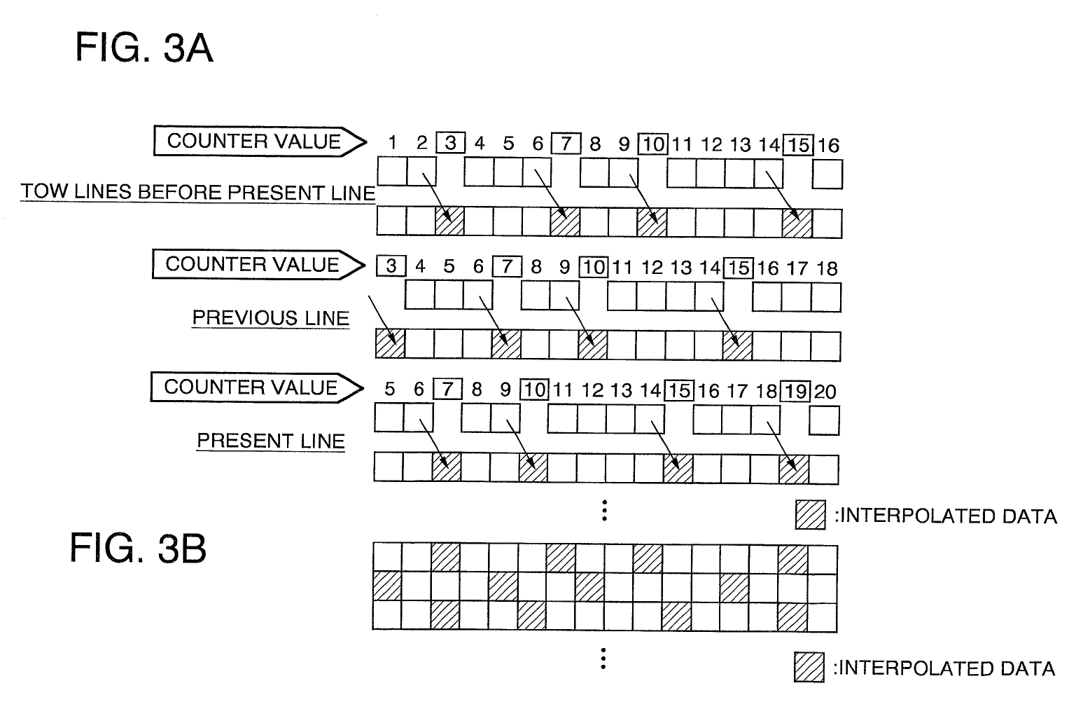

FIGS. 3A and 3B are diagrams showing the initial part of a pixel data line when the enlargement processing (the interpolation processing of pixel data) is carried out in accordance with the present invention. As shown in FIG. 3A, since an enumerated value in the counter is not reset at every line in the present invention, every line has its own bit numeral numbers different from other lines for the pixels (with hatching) requiring the interpolation Consequently, the pixel data after finishing the enlargement processing become ones like shown in FIG. 3B and the resulting pixels are positioned randomly, which suppresses the emergence of vertical streaks.

In the above example, the maximum value M in the counter 2 is set smaller than N, the number of the pixel data in a line (M<N). When amounting to the value M, the enumerated value of the counter 2 is set back to one by the next input clock signal CLKi. In other words, the counter 2 counts values cyclically in one scanning line. The scaling factor should be programmed so as to satisfy the condition that N is not dividable by M. In the example shown in FIG. 3A, N and M are determined such that N is divided by M with the remainder, two

The second embodiment: Reduction processing

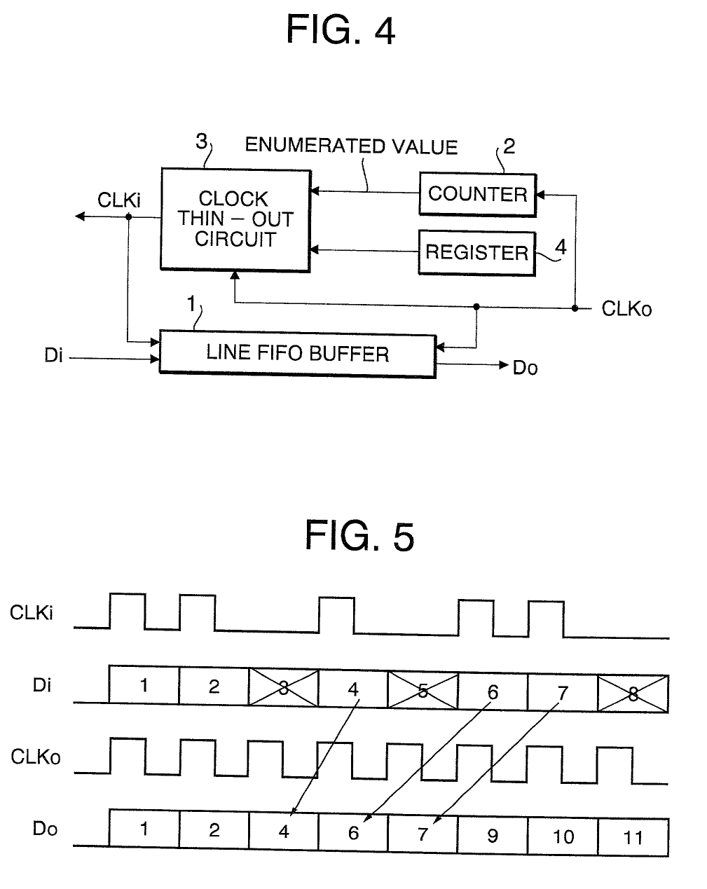

FIG. 4 is a diagram showing the flow of pixel data and clock signals in the case that the present invention is applied to reduction processing and FIG. 5 is a timing chart. Similar reference numerals are used in FIGS. 1 through 5 to designate similar elements. The line FIFO buffer 1 inputs the pixel data Di one by one in synchronization with the input clock signal CLKi, and outputs the pixel data Do one by one in synchronization with the output clock signal CLKo. The counter 2 counts the pulses of the output clock signal CLKo, that is to be the reference clock, and outputs the enumerated value to the clock thin-out circuit 3. The register 4, which stores the timing data revealing which pixel data should be thinned out in accordance with the given scaling, outputs the timing data to the clock thin-out circuit 3. The clock thin-out circuit 3 generates the input clock signal CLKi by thinning out the output clock signal CLKo in accordance with the timing data and outputs it to the line FIFO buffer 1.

The pixel data Di are inputted to the line FIFO buffer 1 successively in synchronization with the input clock signal CLKi. Since the input clock signal CLKi is generated in the clock thin-out circuit 3 by thinning out 3rd clock, 5th clock, 8th clock . . . of the output clock signals CLKo, the 3rd, 5th, 8th . . . pixel data Di are not inputted into the line FIFO buffer 1. The pixel data without the above thinned out pixel data are output as the pixel data Do. The timing data that is the base of the thin-out pattern is inputted from the register 4, and the enumerated value of the output clock signal CLKo are inputted from the counter 2. The pixel data which need thinning out are not read out by thinning out the input clock signal CLKi. It allows the reduction processing with the scaling factor 5/8=62.5%.

The conventional way inputs the reset signal into the counter 2 at every line and resets the enumerated value even in the reduction processing like the above. As a result, the vertical streaks that are the cause of picture degradation are generated. In the present prevention, since the enumerated value in the counter 2 is not reset at every line like the case in the enlargement processing, every line has its own bit numeral numbers different from other lines for the pixels requiring the thinning-out, that is, the thinned out pixels are positioned in random, which suppresses the emergence of vertical streaks.

Incidentally, if a value N designates the number of pixels in one line, a value M designates the maximum value counted by the counter 2 and N (mod M)≡0 is proved, the enumerated value in the counter 2 is reset every time at the beginning of a line even without the input of reset signal. The scaling is set in order not to provide such condition.

The above-mentioned vertical streaks are seen conspicuously in the pseudo gray-scale image but not in the bi-level image. Consequently, it is efficient that the enumerated value in the counter 2 is not reset every time at the beginning of a line in the pseudo gray-scale image but reset in the bi-level image like the conventional way. Examples of such conditions are described as a third embodiment.

The third embodiment: Reset control and non-reset control

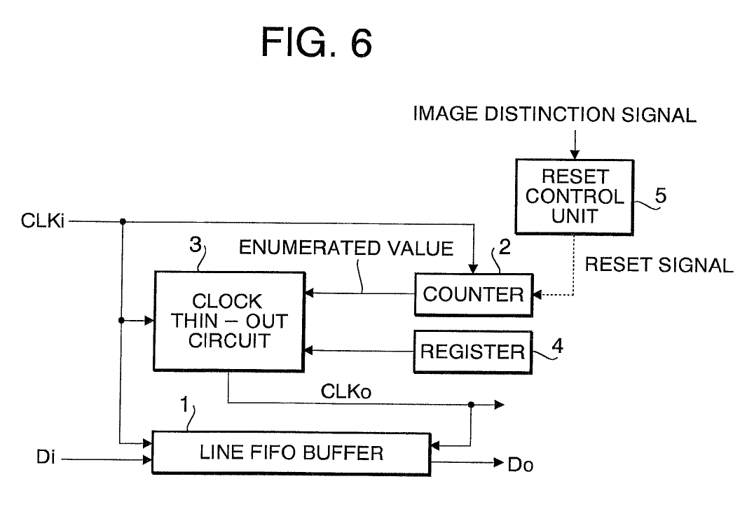

FIG. 6 is a schematic diagram showing the flow of pixel data, clock signals, and reset signals on condition that the first embodiment (enlargement processing) has an additional control function of resetting. Elements and parts in FIG. 6 common to the ones in FIG. 1 are given the same numbers or marks as in FIG. 1 and the explanation of them are abbreviated.

A reset control unit 5 outputs a reset signal to the counter 2 at the end of every line if the image is not a pseudo gray-scale image Receiving said reset signal, the counter 2 resets its own enumerated value at the beginning of a line.

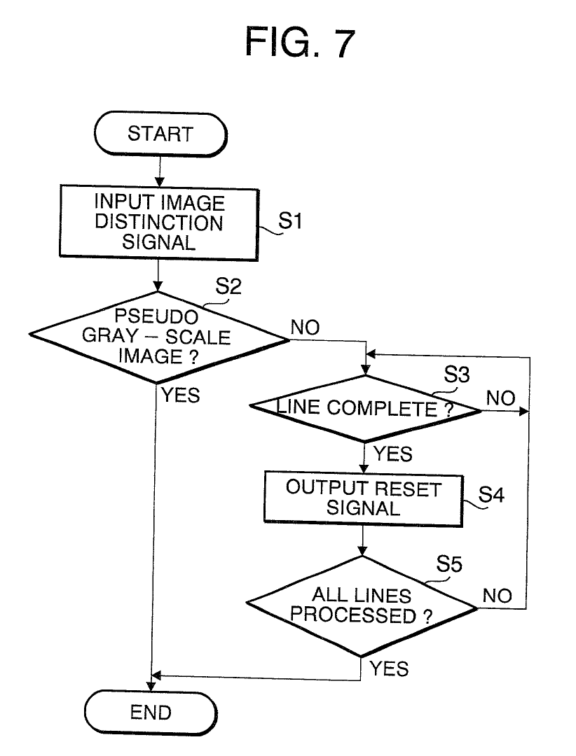

FIG. 7 illustrates a flowchart showing the operations of the reset control unit 5. The reset control unit 5 receives an image distinction signal (step S1) and judges whether the present image is a pseudo gray-scale image or not in accordance with said signal (step S2). Unless the image is a pseudo gray image that likely produces vertical streaks (step S2: No), the reset control unit 5 outputs a reset signal to the counter 2 (step S4) every time it detects the end of a line (step S3: YES). Outputting of the reset signal continues until all lines are processed (step S5: YES). If the image is ,on the other hand, a pseudo gray-scale image (S2: YES), the reset control unit 5 does not output a reset signal.

The above is the case where the reset control unit is added to the first embodiment. It is needless to say that the same control unit can be applied to the second embodiment (the reduction processing).

What is claimed is:

1. An image processing method for providing interpolation processing of pixel data in accordance with an enumerated value of a counter counting a reference clock in a unit which is composed of a prescribed number of pixel data, comprising the steps of:
keeping a final enumerated value of the counter for a former unit instead of resetting it; and,
carrying out a counting processing at a beginning of a current unit with a consecutive enumerated value from the kept final enumerated value.

2. The image processing method as in claim 1, wherein one unit corresponds to the pixel data in one scanning line.

3. The image processing method as in claim 1 further including the steps of:
storing the pixel data in a memory in synchronization with a write clock;
reading out the pixel data from the memory in synchronization with a read clock; and
interpolating the pixel data by generating the read clock through thinning out the write clock in accordance with the enumerated value of the counter.

4. The image processing method as in claim 3, wherein one or more prescribed number of clocks are thinned out from the write clocks in accordance with a value set in a register.

5. An image processing method for thinning out pixel data according to an enumerated value of a counter which counts a reference clock at every one unit that is composed of a prescribed number of pixel data, comprising the steps of:
keeping a final enumerated value of the counter for a former unit instead of resetting it; and,
carrying out a counting processing at a beginning of a current unit with a consecutive enumerated value from the kept final enumerated value.

6. The image processing method as in claim 5, wherein one unit corresponds to the pixel data in one scanning line.

7. The image processing method as in claim 5 further including the steps of:
storing the pixel data in a memory in synchronization with a write clock;
reading out the pixel data from the memory in synchronization with a read clock; and
thinning out the pixel data by generating the write clock through thinning out the read clock in accordance with the enumerated value of the counter.

8. The image processing method of claim 7, wherein one or more specified clocks are thinned out from the read clock in accordance with a value set in a register.

9. An image processing method for interpolating pixel data according to an enumerated value of a counter which counts a reference clock in every one unit that is composed of a prescribed number of pixel data, comprising the steps of:
not resetting a final enumerated value of the counter for a former unit at a beginning of counting for a current unit if the pixel data are pseudo gray-scale; and
resetting the final enumerated value of the counter for the former unit at the beginning of the current unit if the pixel data are bi-level.

10. The image processing method as in claim 9, wherein one unit corresponds to the pixel data in one scanning line.

11. The image processing method as in claim 9 further including the steps of:
storing the pixel data in a memory in synchronization with a write clock;
reading out the pixel data from the memory in synchronization with a read clock; and
interpolating the pixel data by generating the read clock through thinning out the write clock in accordance with the enumerated value of the counter.

12. The image processing method as in claim 11, wherein one or more specified clocks are thinned out from the write clock in accordance with a value set in a register.

13. An image processing method for thinning out pixel data according to an enumerated value of a counter which counts a reference clock at every one unit that is composed of a prescribed number of pixel data, comprising the steps of:
not resetting a final enumerated value of the counter for a former unit at a beginning of a current unit if the pixel data are pseudo gray-scale; and
resetting the final enumerated value of the counter for the former unit at the beginning of the current unit if the pixel data are bi-level.

14. The image processing method as in claim 13, wherein one unit corresponds to the pixel data in one scanning line.

15. The image processing method as in claim 13 further including the steps of:
storing the pixel data in a memory in synchronization with a write clock;
reading out the pixel data from the memory in synchronization with a read clock; and
thinning out the pixel data by generating the write clock through thinning out the read clock in accordance with the enumerated value of the counter.

16. The image processing method as in claim 15, wherein one or more specified clocks are thinned out from the read clock in accordance with a value set in a register.

17. An image processing apparatus for providing interpolation processing with one unit which is composed with a prescribed number of pixel data to be inputted, comprising:
a memory for storing inputted pixel data;
a counter for counting a reference clock;
a clock thin-out circuit for generating a read clock by thinning out a write clock of the pixel data from the memory in accordance with an enumerated value of the counter; and
a reset control unit for controlling resetting and non-resetting of the counter at a beginning of the unit.

18. The image processing apparatus as in claim 17, wherein one unit corresponds to the pixel data in one scanning line.

19. An image processing apparatus for providing thin-out processing with one unit which is composed with a specified number of pixel data to be inputted, comprising:
a memory for storing inputted pixel data;
a counter for counting a reference clock;
a clock thin-out circuit for generating a write clock by thinning out a read clock of pixel data to the memory in accordance with an enumerated value of the counter; and
a reset control unit for controlling resetting and non-resetting of the counter at a beginning of the unit.

20. The image processing apparatus as in claim 19, wherein one unit corresponds to the pixel data in one scanning line.
